(19) United States
(12) Patent Application Publication
(10) Pub. No.: US 2006/0085293 A1
(43) Pub. Date: Apr. 20, 2006

(54) System and method for processor-based inventory data collection and validation

(76) Inventor: Robert J. Melucci, San Diego, CA (US)

Correspondence Address: AKIN GUMP STRAUSS HAUER & FELD, LLP, P O BOX 688, DALLAS, TX, 75313-0688, US

(21) Appl. No.: 10/932,472

(22) Filed: Sep. 1, 2004

(51) Int. Cl. G06F 17/30

(52) U.S. Cl. 705/28

(57) ABSTRACT

A system and method for collecting and validating inventory data is disclosed. In one embodiment of the invention, a processor-based inventory data collection system for efficiently collecting and validating inventory data includes a central processor coupled to a system bus. The central processor is adapted to receive the inventory data and operable to validate the inventory data using a plurality of program codes. At least one flash memory is coupled to the system bus. The flash memory is adapted to store inventory data as the data is entered into the device and also adapted to store the program codes. The invention includes at least one random access memory coupled to the system bus. The random access memory is adapted to store validation tables and validated inventory data. The invention includes a keyboard for entering the inventory data into the computer. The invention includes a display operable to show a report of the inventory data collection.

### TECHNICAL FIELD

This invention relates to processor-based data collection systems and methods and, more particularly, to a processor-based system and method for collection, validation and consolidation of inventory data.

### BACKGROUND OF THE INVENTION

Accurate inventory information is vital to the success of many businesses engaged in the sales of goods and merchandise. A business such as a retail store, must maintain a reasonably accurate inventory. This information is essential to meeting the demands of its customers. If the retail store is able to meet the demands of the customer by maintaining a reasonable level of inventory, the retail store earns a profit from the sale of that merchandise. The retail store also increases the likelihood that the customer will return to shop. In contrast, if the retail store is out of one or more items, customers seeking the item will be disappointed. A disappointed customer will most likely shop at another store, and the retail store will lose the customer's purchase. Furthermore, the retail store may lose the customer in the long-term because the customer may conclude that a well-stocked store can better meet their needs.

When an item is sold, the inventory level of the item decreases. The retail store typically re-stocks the item before the inventory level becomes too low or the store completely runs out of the item. In order to be able to restock the item before the inventory level gets too low, the retail store must monitor the inventory regularly. In fact, most retail stores must monitor the inventory frequently to ensure they have sufficient supplies to meet the regular demands of the customer.

Typically, a retail store keeps its inventory information stored in a computerized system. This system will detect errors in inventory levels due to customer or employee theft, shipping or receiving errors, and product mislabeling. In order to monitor the inventory accurately, an employee or some other individual must periodically physically count each item to validate the computerized inventory information. However, in large retail stores that stock hundreds of thousands of items, it is difficult for a retailer to manually count the items and collect the inventory data. Special devices are often used to count the items stacked on shelves.

Retail stores often contract with a service provider to collect and consolidate their inventory data. The service provider usually has operators that use specialized computers or other hand-held machines to collect the inventory data. Outside services are also used to provide an independent opinion of the inventory losses for financial reporting purposes.

Conventional computers and hand-held machines (“hand-held machines”) designed to collect inventory data do not allow efficient collection and validation of inventory data. Conventional hand-held machines also do not provide efficient consolidation and reporting of inventory data, nor do they perform complex inventory data manipulation, validation and consolidation at a high speed. Conventional hand-held machines also do not provide protection against power failure, or provide efficient transfer of inventory data to external devices.

Accordingly, there exists a need for computers and hand-held machines that allow efficient collection and validation of inventory data, provide efficient consolidation and reporting of inventory data, and perform complex inventory data manipulation, validation and consolidation at a high speed. There also exists a need for computers and hand-held machines that provide protection against power failure and provide efficient transfer of inventory data to external devices.

### SUMMARY OF THE INVENTION

The present invention is a system and method for collecting and validating inventory data. An important aspect of the invention is that an operator can efficiently collect inventory data using a hand-held computer, and then validate and report the data.

In one embodiment of the invention, a processor-based inventory data collection system for efficiently collecting and validating inventory data includes a central processor coupled to a system bus. The central processor is adapted to receive the inventory data and operable to validate the inventory data using a plurality of program code. Flash memory is coupled to the system bus. The flash memory is adapted to store inventory data as the data is entered into the device and also adapted to store the program code.

The invention includes random access memory coupled to the system bus. The random access memory is adapted to store validation tables and validated inventory data. The validation tables are used by the central processor to validate the inventory data. A scanner interface is adapted to couple an external scanner to the central processor and transfer the inventory data to the central processor from the external scanner. The invention includes a keyboard for entering the inventory data into the computer, and includes a display to show a report of the inventory data collection. An infra-red transceiver is coupled to the central processor operable to provide wireless communication with external devices. The invention includes a display operable to show a report of the inventory data collection.

### BRIEF DESCRIPTION OF THE DRAWINGS

FIG. 1 is a simplified, high-level block diagram of an inventory data collection system.

FIG. 2 is a detailed block diagram of a data collection system in accordance with one embodiment of the invention.

FIG. 3 is a flow diagram of a typical inventory data collection process in accordance with one embodiment of the invention.

FIG. 4 shows an example error message displayed by the data collection system.

FIG. 5 shows an example of the display while inventory data is being collected.

FIG. 6 shows a hand-held inventory data collector in accordance with one embodiment of the invention.

### DETAILED DESCRIPTION OF PREFERRED EMBODIMENTS

The various features and methods of the invention will now be described in the context of inventory data collection. Those skilled in the art will recognize that the invention is applicable to other types of data collection.

Throughout the description of the embodiments, implementation-specific details will be given on how the invention is used to efficiently collect inventory data. These details are provided to illustrate the preferred embodiments of the invention and not to limit the scope of the invention. The scope of the invention is set in the claims section.

The present invention provides a solution to the previously-discussed problems. In one aspect, the invention allows a business or an individual to maintain accurate inventory information. The invention is a system and method for processor-based inventory data collection. The invention can be incorporated into a personal data assistant (PDA), tablet PC, or any other hand-held computer. In a preferred embodiment, the invention is implemented in a battery operated hand-held computer for efficiently collecting inventory data.

The inventory data is typically collected in a retail establishment or a warehouse where a physical inventory of merchandise is required to be taken. The merchandise is typically stored on shelves or stacked in another manner. The invention allows an operator to efficiently take a physical count of the merchandise. The operator may be an employee of the retail establishment or may be employed by an entity that specializes in taking physical inventories for retail establishments and other businesses. The operator may collect the inventory data as part of a regular audit of the inventory, or as part of a routine check of the physical inventory.

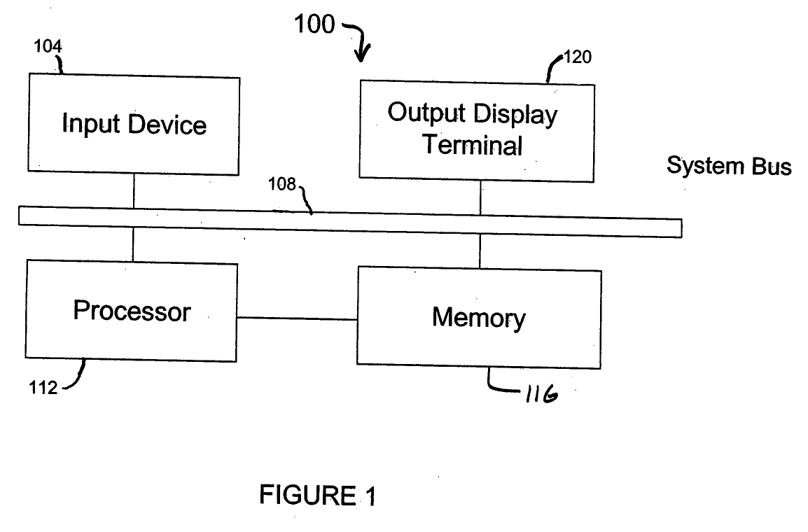

FIG. 1 is a simplified, high-level block diagram of the inventory data collection system 100. The data collection system 100 includes an input device 104 coupled to a system bus 108 and the processor 112. The input device 104 may be a keyboard or an attached hand-held bar code scanner. The input device may also be an external device such as an RFID reader, a counting scale, or a device attached via a PC card or compact flash card connector. An RFID reader is a tag used to track cases or pallets of goods. An operator enters inventory data into the data collection system 100 through the input device 104.

A central processor 112 is coupled to the system bus 108. The central processor 108 can access the inventory data entered into the system 100 over the system bus 108. The central processor 112 performs various operations on the inventory data such as validating the data and performing various computations.

An output device 120 is coupled to the system bus 108. In one embodiment, the output device is a graphical liquid crystal display (LCD), which is incorporated into the data collection system 100, and is used to display results of an inventory audit or to display error messages. A printer can also be used as an output device.

A memory 116 is coupled to the system bus 108, and is used to store the program code that runs the data collection system 100 as well as to store inventory data. The central processor 112 accesses the program code and the inventory data in the memory 116 over the system bus 108.

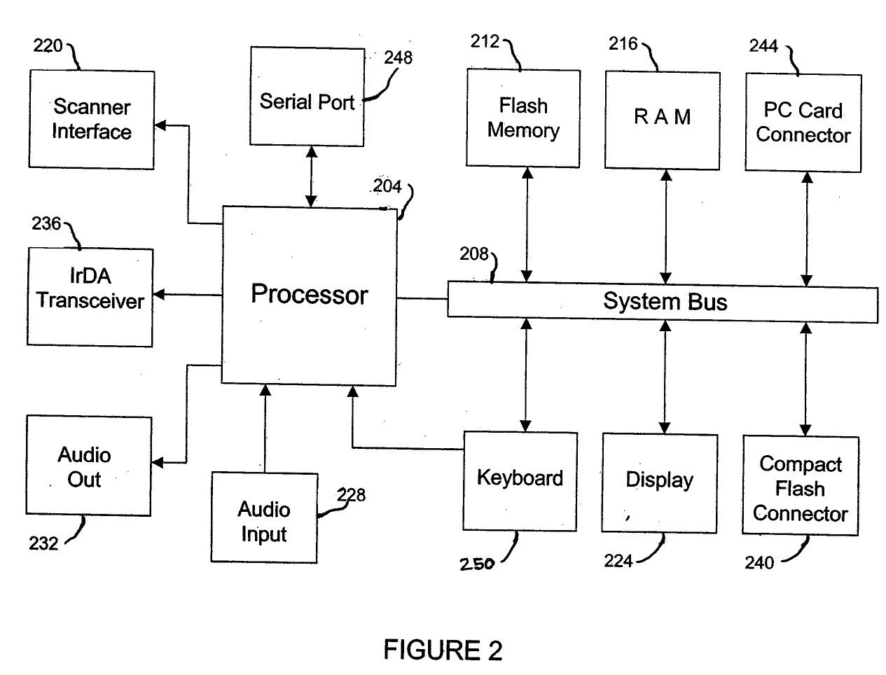

FIG. 2 is a detailed block diagram of the data collection system 200 in accordance with one embodiment of the invention. The data collection system 200 includes a central processor 204 coupled to a system bus 208. In one embodiment, a low power MIPS-based processor (e.g., NEC Vr4121) is used as the central processor 208. The central processor 204 is a high speed microprocessor that enables the system 200 to perform complex data manipulations at a high rate. During inventory data collection, the operator can scan in inventory data at a high rate. The inventory data is validated against known parameters using sophisticated validation logic. The central processor 204 enables fast counting at a high scan rate and executes a validation logic.

The central processor 204 is used to execute program code, and to interface with and control peripheral equipment (e.g., display, serial ports, IRDA transceiver, audio input port and audio output port). The program code is an application program developed specifically for inventory counting. The system bus 208 is used to communicate with memory, a keyboard, a PC card connector, a compact flash connector and an expansion interface. The operation of these components will be described later.

One or more flash memory 212 is coupled to the system bus 208, and is used to store one or more programs as well as the inventory data. In one embodiment, the flash memory 212 stores program code for the central processor 204 and the inventory data. The program code includes the code for validation logic and other installations for carrying out computations during inventory data collection process. As inventory data is entered into the system 200, the data is written into the flash memory. The flash memory 212 is non-volatile, and therefore can retain information even when power is removed from the data collection system 200. The program code for the central processor 204 is stored in the flash memory 212 so that a user need not reload the program code if the system 200 loses power. For example, the system may lose power in the event of a battery malfunction. The inventory data is stored in the flash memory 212 to protect the data from battery, software or hardware malfunction.

One or more random access memory (RAM) 216 is coupled to the system bus 208. In one embodiment, Synchronous Dynamic Random Access Memory (SDRAM) is used. The RAM 216 is used to execute the program code and store values that change frequently or require high speed access.

The RAM 216 includes one or more accumulators. As will be described further, after the inventory data is validated, the data is summarized in the accumulators. The stored data is used to track and audit the entered information. The RAM 216 also stores validation tables which are used to validate the inventory data. By storing the validation tables in SDRAM, power consumption is reduced, because the RAM 216 uses less power than the flash memory, thus extending the battery life of the data collection system 200. Additional memory can be added to the system 200 through an internal compact flash connector or an external PC card connector.

A scanner interface 220 couples the central processor 220 to an external hand-held scanner. The inventory data can be entered into the system 200 by the scanner. The scanner scans inventory data in the form of bar codes, which are then decoded into serial data and relayed to the central processor 204. In one embodiment, the scanner interface 220 is an electrostatic discharge (ESD) protected scanner port. A special cable and connector capture mechanism connects the scanner to the scanner interface 220. The cable connector may incorporate a cable strain relief device that minimizes strain-related cable failures.

A keyboard 220 is coupled to the system bus 208. The inventory data may be entered into the data collection system 200 from the keyboard 220. In one embodiment, the keyboard incorporates circuitry to eliminate a phantom key condition that occurs in standard key switch matrix arrangements. A phantom key condition occurs when three of four keys in the corners of a square are pressed simultaneously. By eliminating the phantom key condition, high speed data entry by the operator is facilitated. Tactile feedback key switches are utilized for speed and accuracy. In one embodiment, the keyboard includes custom keys that are labeled specifically for the inventory data collection process. The keyboard is built around a full-size calculator keypad. The keyboard has large keys for commonly used functions such as enter and section change keys.

The data collection system 200 includes a display 224 coupled to the system bus 208. The display is used to present information such as results of an inventory audit. In one embodiment, a graphical liquid crystal display (LCD) is used. The LCD's large size permits the display of a large amount of information, which is useful to the operator. In one embodiment, the font size of the LCD can be adjusted to display more information with a smaller font or less information with a larger font.

The data collection system 200 includes an audio input port 228 and an audio output port 232 coupled to the processor 204. The audio input port 228 can accommodate a microphone. By providing voice input capability, the operator does not need to enter the information via a keyboard. The operator may scan a bar code to identify the item and then speak, rather than key in, the quantity term. In one embodiment, the data collection system 200 includes speech recognition software that allows the operator to input inventory data via the microphone. Verbal memos can also be recorded, stored and transmitted with the inventory data. The audio output port 232 can power an internal speaker, an external earphone or an external tactile vibrator. The internal speaker, the external earphone or the tactile vibrator can be used to sound an error tone to gain the attention of the operator.

In one embodiment, IrDA (infra-red) transceiver 236 is coupled to the processor 204. The IrDa transceiver 236 provides wireless communication with other data collection systems, printers or personal computers. The IrDA transceiver 236 is used to transfer inventory data to or from the data collection system 200.

In one embodiment, the data collection system 200 includes a compact flash connector 240 and a PC card connector 244. The PC card connector 244 is externally accessible, and is used to provide hardware expansion capability such as interface devices or additional memory. Removable memory cards may be attached to the PC card connector 244 as a data transfer medium. The data collection system 200 can be cold booted from a linear or Advanced Technology Attachment (ATA) flash card plugged into the PC card connector 244. The compact flash connector 240 provides additional hardware expansion capability.

In one embodiment, the system bus 208 is controlled by a complex programmable logic device (CPLD). The CPLD is used to adjust the timing of the system bus 208 to better conform to standard industry specifications.

In one embodiment, the stored data in the inventory data collection device 200 is transmitted to a central computer for permanent storage or additional processing. The stored data can be transmitted over the Internet or any other communication link, including wireless communication. The central computer can be maintained by an entity engaged in collecting inventory data for retail businesses. The central computer can also be maintained by the retail business itself.

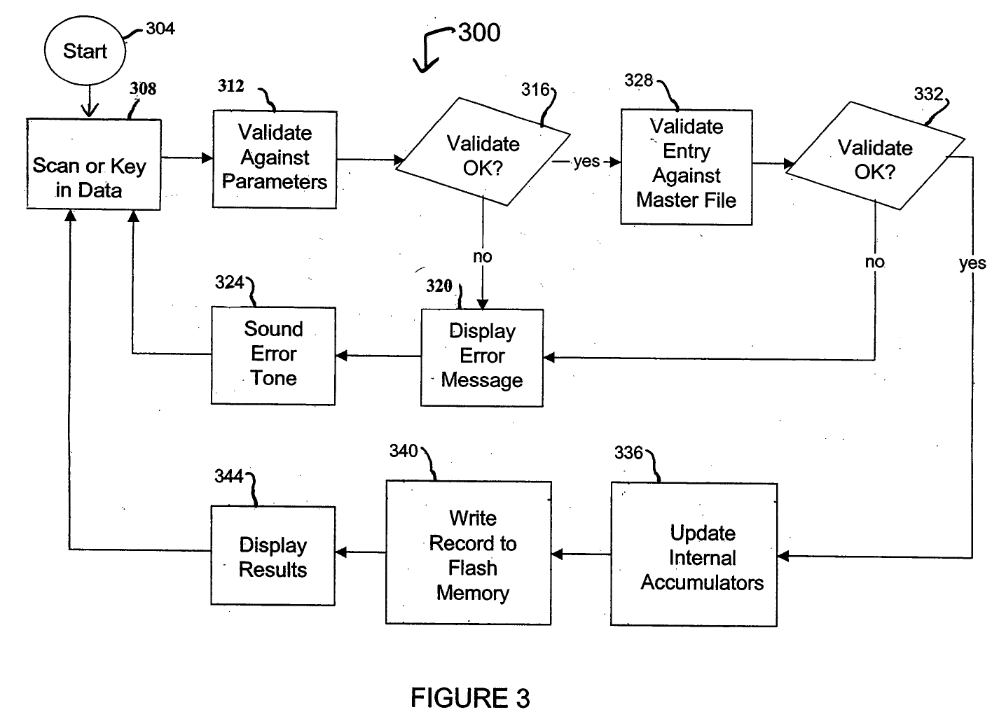

FIG. 3 is a flow diagram of an inventory data collection process in accordance with one embodiment of the invention. The process starts in step 304 and moves to step 308 where the inventory data is scanned or keyed in. The inventory data can be entered into the system from the keyboard or an attached hand-held bar code scanner. The inventory data can also be captured utilizing an external device such as an RFID reader plugged into the serial port, compact flash connector, or the PC card slot.

In one embodiment, the inventory data collection process includes capturing location information, a stock keeping unit (SKU) number, an item quantity, and a price. The location information may include a section or an area identifier that identifies an area or a section of a shelf where the inventory is located. The SKU number is used to uniquely identify an inventory item, and is preferably captured via an external hand-held scanner. The item quantity is either assumed to be a single unit or is entered via the keyboard. The item quantity can also be calculated via a built-in calculator by entering the unit width, depth, and height of a product as it is stacked on a shelf. The following is an example of a typical internally stored record. This information is compressed to save storage space.

| SECTION | AREA | SKU | PRICE | QTY |
|---|---|---|---|---|
| 2110 | 55 | 546871 | 00754 | 00079 |

Other information such as breakdown, department, or class can also be stored. The information also can be entered, scanned, or extracted from an internally stored item master file.

Next, the process moves to step 312 where the captured data is validated against a set of parameters. In one embodiment, the data is validated against a set of restrictive parameters that is designed to reduce the likelihood of invalid or incomplete information. The restrictive parameters can include minimum and maximum restrictions on field lengths and entered values. The restrictive parameters can also include check digit validation calculations. For example, an entered SKU number can be restricted to only eight digits or a specific number range. If the entered value contains a check digit, the device can calculate the correct check digit and compare that against the entered one. A check digit is a calculated value embedded in a number and is used to reduce keying errors. The check digit is usually the last digit of the number and is calculated using an algorithm using the other digits in the number. The check digit can provide a fast first pass validation without the need to perform a look-up in a master file. If the entered check digit does not match the calculated one, the record can be rejected.

The invention can scan any common bar code symbology. Scanned entries can be restricted to specific bar code symbologies for different fields. For example, the operator can restrict a section tag to 3 of 9 bar code symbols, an item scan to a Universal Product Code (UPC) or interleaved 2 of 5 bar codes, and shelf label tags to Code 128 bar codes. A section tag is an identifying tag indicating what section of a store, stockroom, or warehouse the merchandise is located in, and has a bar code or other identifying value. The section tag can be used to locate the counted merchandise, compare the count with a previous count for that section, or compare the count with a current summary value from an automated inventory system. A shelf label tag is a retailer installed tag typically placed on the store shelf under the merchandise, and can be a bar code or a SKU number. The shelf label tag often has a price and a description of the item. During inventory data collection, the information on the self label tag is often captured.

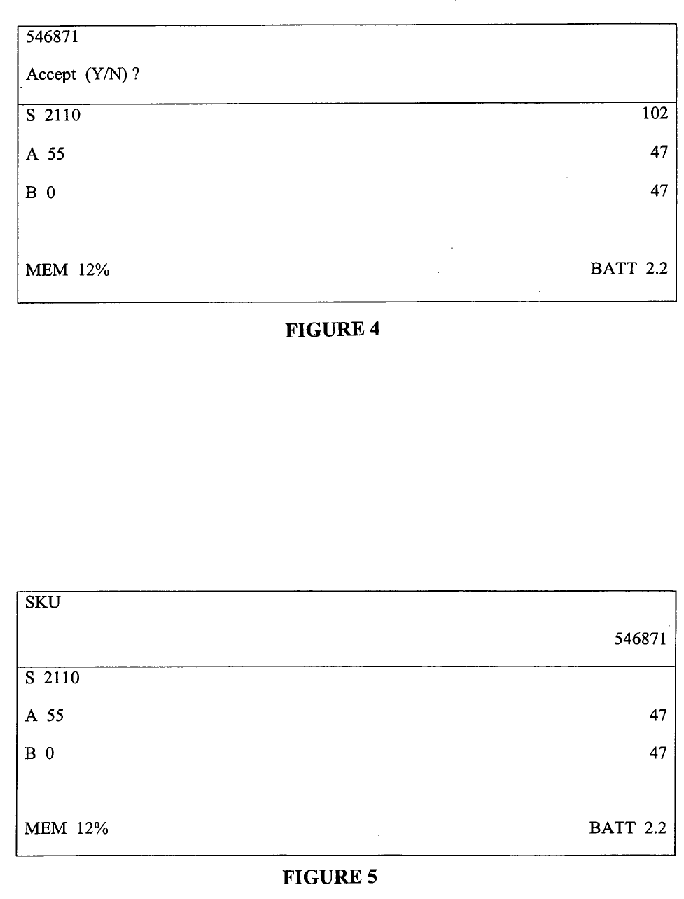

Next, the process moves to step 316 where it is determined whether the captured data is successfully validated against the set of restrictive parameters. If the captured data is not successfully validated, an error message is displayed in step 320. The error message informs the operator about a problem with the captured data and provides information on how to resolve the problem. FIG. 4 shows an example error message. In FIG. 4, the operator entered in an SKU number of 546871. The system attempted to locate the SKU number in the master file, but the SKU number was not found. In the error message, the operator is asked if the SKU number should be accepted anyway. The operator responds to the question by pressing the YES or NO key on the system keypad.

In one embodiment, an optional error tone may be sounded in step 324. The error tone is sounded to gain the attention of the operator. Alternatively, an error tone alone is sounded without an associated error message, which allows the operator to focus on the merchandise to be counted and not on the display. The error tone sound can be delivered via an internal speaker, an external earphone, or an external tactile vibrator. A tactile vibrator is normally used to accommodate hearing impaired operators. The process then returns to step 308.

If the captured data has been validated against a set of restrictive parameters, the process moves to step 328. In step 328, the captured data is validated against a master file. In one embodiment, the captured data is validated against an inventory item master file, which usually contains a list of valid SKU numbers. The master file may contain information that can be used to validate other data such as price or quantity. The master file may also be used to provide information to generate inventory reports. A master file may contain many thousands of records. An example record in a master file is shown below:

| UPC-CODE | ITEM-DESCRIPTION | SKU | PRICE | QUANTITY |
|---|---|---|---|---|
| 071142012349 | BOTTLED WATER | 546871 | 00754 | 00079 |
| | 24 OZ SPORTS | | | |
| | PACK | | | |

In the above example, the UPC field provides the Universal Product Code, which is commonly used to uniquely identify an item. The description field can include the generic name of the item. Also, the description field can also provide item identification feedback to the operator, or can be used to generate a report. The SKU field includes the stock keeping unit number that can be used as an alternative item identifier. The price term can be used to prompt the operator for additional information on certain price points. The quantity term can be used as a reasonableness check against the quantity observed. Other information such as department, class, or section can also be included in the master file.

In step 332, it is determined whether the captured data has been successfully validated against the master file. If the captured data is not successfully validated, the process returns to step 320 where an error message is displayed. As described before, an error tone may be sounded in step 324, and the process returns to step 308.

If the captured data is successfully validated against the master file, the process moves to step 336. In step 336, the captured data is stored in one or more accumulators in the RAM. The stored data in the accumulators is used to track and audit entered information. In one embodiment, the stored data in the accumulators include data related to the section to be counted, area, breakdown and unique SKU counters. These are often used as manual audit checks for reasonableness and to aid the operator in keeping track of what was counted. For audit checks, the operator may count a section manually and compare the total with the stored section total count. The unique SKU counter tells the operator how many different SKU numbers have been entered.

The process next moves to step 340 where the data is stored in flash memory to preserve the data from being lost due to an unexpected malfunction such as a power loss.

The process next moves to step 344 where the results are presented to the operator on the terminal display. Additional information that may be helpful to the operator may be calculated and displayed, or extracted from the master file and displayed.

The validated data can be consolidated in a central computer. In one embodiment, the central computer can receive inventory data from a plurality of hand-held, data collection computers. The operator scans in the inventory data, or otherwise enters the data, using the hand-held computer. The data can be again validated and reported by the computer. The validated data is then transferred to the central computer that maintains the inventory data. The operator can transfer the validated data or results of an inventory audit over the Internet or other communication link. In one embodiment, the operator connects the hand-held computer to the Internet, and transmits the results of the inventory audit to the central computer. Thus, the central computer can store inventory data originating from many retail establishments or warehouses. Consider, for example, a scenario where a retail chain establishment operates hundreds of stores in different locations. The present invention can be used to collect and validate inventory data from the stores in different locations, and the data can be consolidated in the central computer.

FIG. 5 shows results of an inventory audit displayed on the terminal. In the example in FIG. 5, the SKU field indicates an SKU number of 546871 was keyed in or scanned in by the operator. The operator counted 102 pieces so far in section 2110 and 47 pieces in area 55 of section 2110. The results also indicate that 12% of the total memory capacity has been consumed and the internal battery voltage is at 2.2 volts. The process next returns to step 308 where the process begins again.

The described process can be modified and enhanced as required for a specific inventory or other data collection task. This document does not describe all terminal functions. It excludes the more advanced functions including such tasks as section changes, editing functions, the downloading of software or configuration information, the manual configuration of the terminal, the transferring of data to another device such as a PC, report generation, and hardware diagnostics.

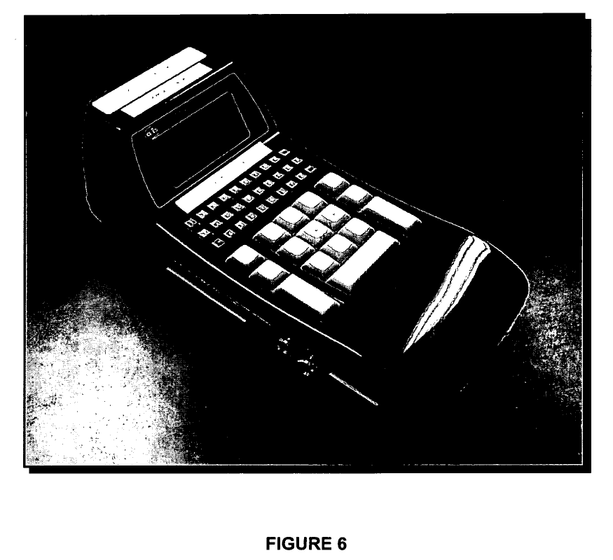

FIG. 6 shows a hand-held inventory data collector in accordance with one embodiment of the invention. The data collector utilizes the system 200 shown in FIG. 2 and the process of FIG. 3. The data collector is designed to optimize data collection speed, survive rough physical treatment, and minimize battery consumption. It is designed to provide a cost-effective solution to inventory data collection.

The data collector utilizes ultra-capacitors, which allow it to continue to operate during interruptions due to battery power loss. A battery power loss may occur if the data collector is accidentally dropped by the operator. The data collector includes a flash memory and a SDRAM. As inventory data is entered into the data collector, the data is written into the flash memory, thus providing a high degree of safety. When the data collector is off, the SDRAM goes into a self-refresh mode. During the self-refresh mode, the total current consumption by the data collector is quite low. The data collector uses a set of batteries, which maintain the SDRAM data for several months. Also, the ultra-capacitors maintain the SDRAM data for several minutes during battery changes. The data collector utilizes transient voltage suppression (TVS) diodes to minimize effects of ESD. Surface mount technology (SMT) is utilized for improved resilience to vibrations and mechanical shocks.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A processor-based inventory data collection computer for efficiently collecting and validating inventory data, comprising:
a central processor coupled to a system bus, the central processor adapted to receive the inventory data and operable to validate the inventory data using a plurality of program codes;
at least oneflash memory coupled to the system bus, the flash memory adapted to store inventory data as the data is entered into the device and also adapted to store the program code;
at least onerandom access memory coupled to the system bus, the random access memory adapted to store validation tables and validated inventory data, the validation tables used by the central processor to validate the inventory data;
a scanner interface adapted to couple an external scanner to the central processor and operable to transfer the inventory data to the central processor from the external scanner;
a keyboard for entering the inventory data into the computer;
an infra-red transceiver coupled to the central processor operable to provide wireless communication with external devices;
a display operable to show a report of the inventory data collection;

2. The inventory data collection system of claim 1 wherein the flash memory stores program codes for validation logic for validating the inventory data.

3. The inventory data collection system of claim 1 wherein the flash memory is a non-volatile memory capable of retaining stored data when power is removed from the system.

4. The inventory data collection system of claim 1 wherein the scanner interface is an electrostatic discharge protected scanner port.

5. The inventory data collection system of claim 1 further comprising an audio input port for coupling an external microphone to the processor, wherein an operator can input inventory data via the microphone.

6. The inventory data collection system of claim 1 further comprising an audio output port for coupling a speaker to the system.

7. The inventory data collection system of claim 1 further comprising a PC card connector adapted to couple additional memory to the system.

8. An inventory data collection and validation system, comprising:
a central processor coupled to a system bus, the central processor adapted to receive inventory data and operable to validate the inventory data using a plurality of program codes;
at least one memory module coupled to the system bus, the memory module adapted to store inventory data as the data is entered into the device and also adapted to store the program codes;
an external scanner coupled to the central processor and operable to scan in inventory data and to transfer the inventory data to the central processor;
a keyboard, coupled to the system bus, for entering the inventory data into the system;
a display operable to show a report of the inventory data collection;

9. The inventory data collection system of claim 8 further comprising a flash memory adapted to store program codes for validation logic and for validating the inventory data.

10. The inventory data collection system of claim 9 wherein the flash memory is non-volatile memory capable of retaining stored data when power is removed from the system.

11. The inventory data collection system of claim 8 further comprising at least one random access memory coupled to the system bus, the random access memory adapted to store validation tables and validated inventory data, the validation tables used by the central processor to validate the inventory data.

12. The inventory data collection system of claim 8 further comprising an infra-red transceiver coupled to the central processor operable to provide wireless communication with external devices.

13. The inventory data collection system of claim 8 further comprising a scanner interface to couple the external scanner to the central processor.

14. The inventory data collection system of claim 13 wherein the scanner interface is an electrostatic discharge protected scanner port.

15. The inventory data collection system of claim 8 further comprising an audio input port for coupling an external microphone to the processor, wherein an operator can input inventory data via the microphone.

16. A method of collecting and validating inventory data using a hand-held inventory data collection computer, comprising:
entering the inventory data into the computer;
validating the entered data against a set of restrictive parameters, the parameters designed to reduce the likelihood of invalid inventory data;
validating the entered data against a master file, the master file including a list of valid SKU numbers;
displaying an error message if the entered data is not successfully validated against the restrictive parameter and the master file;
storing the validated data in at least one random access memory and in at least oneflash memory;
displaying a report of the inventory in a graphical display.

17. The method of claim 16 wherein the inventory data is scanned in by a scanner.

18. The method of claim 16 wherein the inventory data is entered into the computer by a keyboard.

19. The method of claim 16 further comprising:
entering location information of a merchandise;
entering the SKU number of the merchandise, the SKU number identifying the merchandise;
entering the price term of the merchandise.

20. The method of claim 16 wherein the restrictive parameters include minimum and maximum restrictions on field lengths and entered values.

21. The method of claim 16 further comprising sounding an error tone if the inventory data is not successfully validated against the set of restrictive parameters and the master file.

22. The method of claim 16 further comprising transmitting the entered data to a central computer by an IrDA transceiver.

23. The method of claim 16 further comprising entering inventory data by a microphone coupled to the computer.

24. The method of claim 16 further comprising storing validation tables in the random access memory, the validation tables used to validate the inventory data.

25. The method of claim 26 further comprising connecting the scanner to a scanner interface coupled to the computer.

26. A method of collecting and validating inventory data by an operator using a portable computer, comprising:
scanning bar codes from merchandise to retrieve the inventory data;
transferring the scanned inventory data into the computer;
validating the inventory data against a set of restrictive parameters, the parameters designed to reduce the likelihood of invalid inventory data;
validating the inventory data against a master file, the master file including a list of valid SKU numbers;
displaying an error message if the inventory data is not successfully validated against the restrictive parameter and the master file;
storing the validated data in a random access memory and in a flash memory;
displaying a report of the inventory in a graphical display.

27. The method of claim 26 further comprising:
entering location information of merchandise into the computer;
entering the SKU number of the merchandise into the computer, the SKU number identifying the merchandise;
entering the price term of the merchandise into the computer.

28. The method of claim 26 wherein the restrictive parameters include minimum and maximum restrictions on field lengths and entered values.

29. The method of claim 26 further comprising sounding an error tone if the inventory data is not successfully validated against the set of restrictive parameters and the master file.

30. The method of claim 26 further comprising transmitting the validated data to a central computer by an IrDA transceiver.

31. The method of claim 26 further comprising transmitting the validated data to a central computer over the Internet.

32. The method of claim 26 further comprising storing validation tables in the random access memory, the validation tables used to validate the inventory data.

33. The method of claim 26 further comprising connecting the scanner to a scanner interface coupled to the computer.

34. The inventory data collection system of claim 1 further comprising an audio output port for coupling an earphone to the system.

35. The inventory data collection system of claim 1 wherein the keyboard is a tactile feedback keyboard.

36. The inventory data collection system of claim 1 further comprising a PC card connector for providing hardware expansion capability.
